(19) United States
(12) Patent Application Publication
(10) Pub. No.: US 2014/0131585 A1
(43) Pub. Date: May 15, 2014

(54) X-RAY IMAGE PICKUP SYSTEM AND CONTROL METHOD FOR X-RAY IMAGE PICKUP APPARATUS

(71) Applicant: CANON KABUSHIKI KAISHA, Tokyo (JP)

(72) Inventor: Toshiya Ishioka, Tokyo (JP)

(73) Assignee: CANON KABUSHIKI KAISHA, Tokyo (JP)

(21) Appl. No.: 14/073,704

(22) Filed: Nov. 6, 2013

(30) Foreign Application Priority Data
Nov. 9, 2012 (JP) 2012-247683

(51) Int. Cl. G01N 23/04; G01T 1/00

(52) U.S. Cl. CPC G01N 23/04; G01T 1/00
USPC 250/370.09; 250/371

(57) ABSTRACT

An X-ray image pickup system includes an X-ray image pickup apparatus having a sensor unit having photoelectric conversion elements arranged in a two-dimensional matrix form, the sensor unit configured to acquire an electric signal corresponding to the intensity of an X-ray generated from an X-ray source by the photoelectric conversion elements and output electric signals as pixel data, an electric circuit configured to perform processing including driving the sensor unit, wiring configured to mutually connect the sensor unit and the electric circuit, and one or more loop circuits each having a loop-shaped conductor and being connected to at least one of an internal component of the electric circuit and the wiring, and a selection unit configured to perform at least one of selection of a loop circuit to be connected among the loop circuits and selection of a state of the loop circuit to be connected.

### BACKGROUND OF THE INVENTION

1. Field of the Invention

The present invention relates to an X-ray image pickup system and a control method for an X-ray image pickup apparatus.

2. Description of the Related Art

Conventionally, an X-ray image pickup system has been commercially available which includes an X-ray image pickup apparatus in which an X-ray emitted from an X-ray source is irradiated to a subject, and a distribution of the intensity of the X-ray transmitted through the subject is detected and is converted to digital image data.

When an X-ray image pickup apparatus creates image data, the image data creation processing or the generated image data itself may be influenced by a magnetic field within an operating environment of the X-ray image pickup apparatus. When a varying magnetic field exists within an operating environment of an X-ray image pickup apparatus, the varying magnetic field passing through a conductor within the X-ray image pickup apparatus may generate current/voltage in the X-ray image pickup apparatus under the law of electromagnetic induction and in this case may have an influence on image data creation processing, which may possibly cause unintended glare other than an image of a subject on a captured image. The same phenomenon may be caused by a movement of an X-ray image pickup apparatus even when a magnetic field present within an operating environment of the X-ray image pickup apparatus does not vary.

Various methods have been proposed in order to address such influences of a magnetic field present within an operating environment of an X-ray image pickup apparatus.

First, a method has been proposed in which a magnetic field within an operating environment of an X-ray image pickup apparatus is detected or analyzed and the result is reflected to image data creation processing.

As a specific embodiment of such a method, U.S. Pat. No. 7,091,491 discloses a method comprising observing a magnetic field with a magnetic field detecting function provided in an X-ray image pickup apparatus and using an observation result of the magnetic field to subtract an influence of the magnetic field from an image. Another embodiment is a method disclosed in Japanese Patent Laid-Open No. 2005-177113 comprising detecting a phase of a magnetic field with a magnetic field detector and using a result of the detection of the phase of the magnetic field to adjust timing of processing of reading an image from a sensor to reduce an influence of the magnetic field.

Next, a method is provided by which a material having a shield effect is added to an X-ray image pickup apparatus or a component of an X-ray image pickup apparatus is replaced by a material having a shield effect to reduce a magnetic field itself passing through the X-ray image pickup apparatus.

As a specific embodiment of the method, Japanese Patent Laid-Open No. 2002-250772 discloses a method by which an X-ray image pickup apparatus is moved to an electromagnetic shield provided within an X-ray image pickup system in processing of creating an image by the X-ray image pickup apparatus to reduce an influence of a magnetic field.

### SUMMARY OF THE INVENTION

An X-ray image pickup system according to the present invention includes an X-ray image pickup apparatus having a sensor unit having a photoelectric conversion elements arranged in a two-dimensional matrix form, the sensor unit configured to convert the intensity of an X-ray generated from an X-ray source by the photoelectric conversion elements to an electric signal and output the electric signals as pixel data, an electric circuit configured to perform processing including driving the sensor unit, wiring configured to mutually connect the sensor unit and the electric circuit, and one or more loop circuits each having a loop-shaped conductor and being connected to at least one of the electric circuit and the wiring, and a selection unit configured to perform at least one of selection of the loop circuit to be connected among the plurality of loop circuits and selection of a state of the loop circuit to be connected. The selection unit has a setting unit configured to perform selection of at least one of the plurality of loop circuits and selection of a state of the loop circuit to be connected and define a plurality of settings as settings for the loop circuit, a deriving unit configured to a value indicating an influence of an external magnetic field in image data acquired by the sensor unit every time the setting unit defines a setting for the loop circuit, and a determination unit configured to determine a setting for capturing an image of a subject as a setting for the loop circuit to be connected on basis of the value indicating an influence of an external magnetic field derived by the deriving unit.

Further features of the present invention will become apparent from the following description of exemplary embodiments with reference to the attached drawings.

### BRIEF DESCRIPTION OF THE DRAWINGS

FIG. 1 illustrates a configuration of an X-ray image pickup apparatus.

FIG. 2 illustrates an arrangement in a surface direction of a sensor unit and an electric circuit.

FIG. 3 illustrates a first example of a magnetic-field influence inhibiting unit.

FIG. 4 illustrates a second example of a magnetic-field influence inhibiting unit.

FIG. 5 illustrates a configuration of an X-ray image pickup apparatus in which a magnetic-field influence inhibiting unit is set automatically.

FIG. 6 is a flowchart describing a first example of an operation of an instruction determining unit.

FIG. 7 illustrates a variation example of a method of deriving a value indicative of a degree of influence of a magnetic field.

FIG. 8 illustrates an arrangement in a height direction of the sensor unit and electric circuit.

FIG. 9 illustrates a configuration of an X-ray image pickup apparatus where the magnetic-field influence inhibiting unit is set manually.

FIG. 10 is a flowchart describing a first example of an operation of a processing device.

FIG. 11 is a flowchart describing a second example of an operation of the instruction determining unit.

FIG. 12 is a flowchart describing a second example of an operation of a processing device.

### DESCRIPTION OF THE EMBODIMENTS

Embodiments of the present invention will be described with reference to drawings. For convenience in describing and writing, parts necessary for description will be simplified as required, and parts unnecessary for description will be omitted.

### First Embodiment

First, a first embodiment of the present invention will be described.

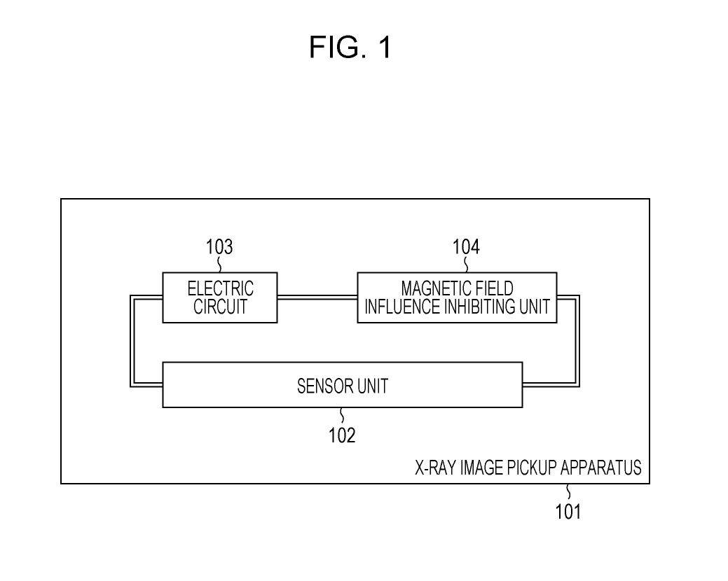

FIG. 1 illustrates an example of a schematic configuration of an X-ray image pickup apparatus.

As illustrated in FIG. 1, an X-ray image pickup apparatus 101 includes a sensor unit 102, an electric circuit 103, and a magnetic-field influence inhibiting unit 104.

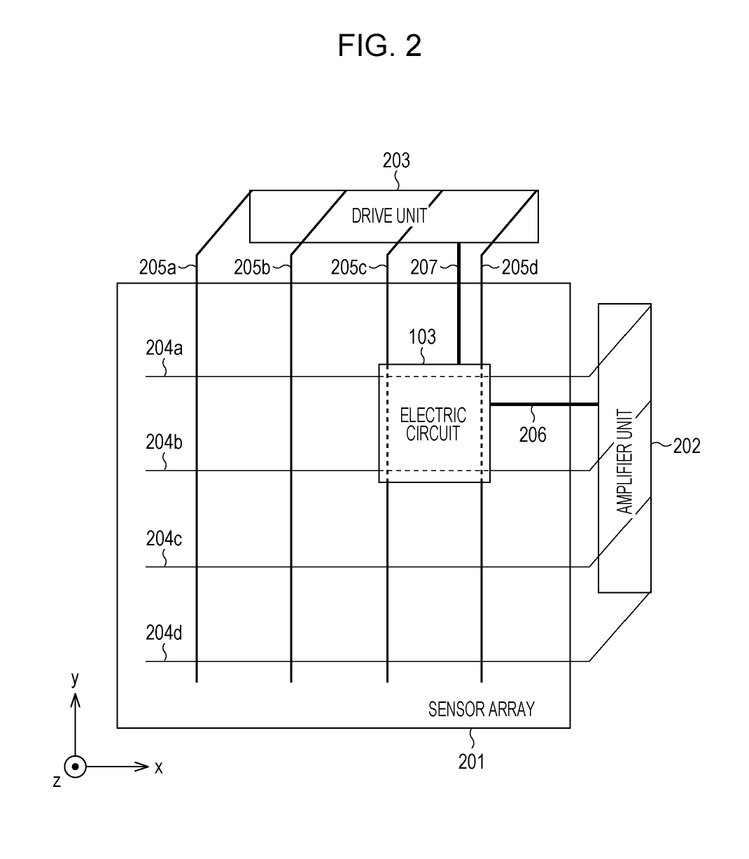

FIG. 2 illustrates an example of an arrangement in a surface direction of the sensor unit 102 and electric circuit 103. More specifically, FIG. 2 is an upper view of the sensor unit 102 and electric circuit 103. The sensor unit 102 converts an intensity of an X-ray from an X-ray source to an electric signal (photoelectric conversion).

The sensor unit 102 has a sensor array 201, an amplifier unit 202, a driving unit 203, read signal lines 204a to 204d, and gate lines 205a to 205d.

The sensor array 201 has photoelectric conversion elements (sensors) arranged in a two-dimensional matrix form. Illustrating 4×4 pixel sensor array 201, for example, it should be understood that the number of pixels included in the sensor array 201 is not limited thereto. The photoelectric conversion of converting an X-ray to electrons may be implemented by any methods such as a method which converts a counting result of photons themselves to an electric signal and a method using a scintillator which converts a radiant ray to light, not limiting to a specific method.

The amplifier unit 202 receives and amplifies pixel data output from the sensor array 201. The pixel data are transmitted through the read signal lines 204a to 204d which mutually connect the sensor array 201 and the amplifier unit 202 and are output to the amplifier unit 202.

The driving unit 203 transmits a gate signal for selecting a sensor which reads pixel data to the sensor array 201. The gate signal is transmitted through the gate lines 205a to 205d which mutually connect the sensor array 201 and the driving unit 203 and is output to the sensor array 201.

The electric circuit 103 includes electronic parts and wiring configured to generate power and control signals required for driving the sensor unit 102, read image data and mutually connect electric parts required for the generation and reading. As illustrated in FIG. 2, the electric circuit 103 is mutually connected with the amplifier unit 202 through a wiring 206. The electric circuit 103 is mutually connected with the driving unit 203 through a wiring 207.

In this way, according to this embodiment, the sensor array 201, amplifier unit 202, electric circuit 103, and driving unit 203 form a closed loop.

The amplifier unit 202, electric circuit 103, and driving unit 203 are disposed in an upper part than the sensor array 201.

The read signal lines 204a to 204d and gate lines 205a to 205d are disposed in an area between the sensor array 201 and the amplifier unit 202, electric circuit 103, and driving unit 203 in a height direction. The gate lines 205a to 205d are disposed in an upper part than the read signal lines 204a to 204d. The read signal lines 204a to 204d may be disposed in an upper part than the gate lines 205a to 205d.

The magnetic-field influence inhibiting unit 104 generates current/voltage in a reverse direction to that of current/voltage which has an influence on image formation by the X-ray image pickup apparatus 101 due to a magnetic field present within an operating environment of the X-ray image pickup apparatus 101 by the law of electromagnetic induction. According to this embodiment, the magnetic-field influence inhibiting unit 104 may adjust a value of the current/voltage in the reverse direction in accordance with the magnetic field present within an operating environment of the X-ray image pickup apparatus 101.

This configuration is given in FIGS. 1 and 2 for illustration purposes only. There is no upper limit to the numbers of any components present within the X-ray image pickup apparatus 101. Other components that those illustrated in FIG. 1 may be included in the X-ray image pickup apparatus 101. For example, FIG. 1 illustrates one electric circuit 103 between the amplifier unit 202 and the driving unit 203. However, a plurality of electric circuits may be disposed between the amplifier unit 202 and the driving unit 203. The X-ray image pickup apparatus 101 may include an electric circuit or mechanism allowing communication with another apparatus.

The magnetic-field influence inhibiting unit 104 includes one or a plurality of loop circuits configured to generate voltage/current with a magnetic field and a part configured to select or adjust the loop circuit or loop circuits. Each of the loop circuits is a circuit having a loop-shaped conductor (of metal).

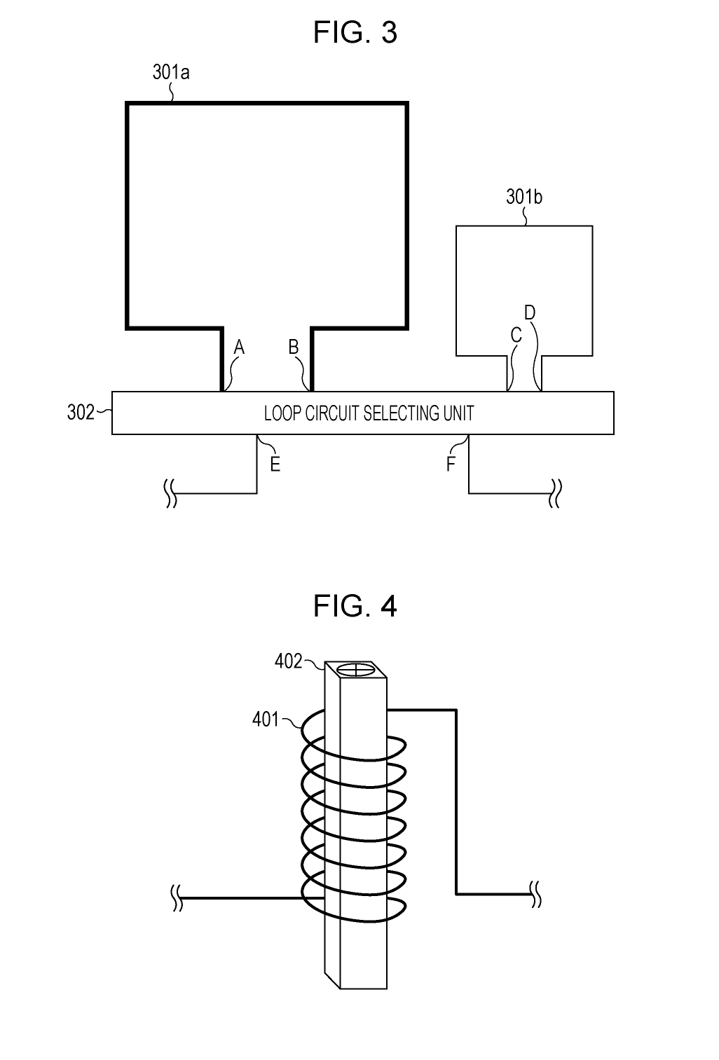

FIG. 3 illustrates a first example of the magnetic-field influence inhibiting unit 104.

The first example of the magnetic-field influence inhibiting unit 104 illustrated in FIG. 3 simultaneously uses one or more of the plurality of loop circuits 301a and 301b to change current/voltage (induced electromotive force) generated by the law of electromagnetic induction. In order to do so, one or two of the loop circuits 301a and 301b having different characteristics from each other are selected by a loop circuit selecting unit 302. The different characteristics of the loop circuits here refer to different characteristic values which influence on current/voltage generated by electromagnetic induction, such as areas of loop circuits, directions of surfaces of loop circuits, and values of resistance of loop circuits. In this way, the first example of the magnetic-field influence inhibiting unit 104 has the plurality of loop circuits 301a and 301b and the loop circuit selecting unit 302.

Here, the loop circuit 301 selected by the loop circuit selecting unit 302 has one end connected to the electric circuit 103 and the other end connected to the amplifier unit 202. However, the loop circuit 301 may be connected, without limiting thereto, any unit or circuit. For example, the loop circuit 301 selected by the loop circuit selecting unit 302 may have one end connected to the electric circuit 103 and the other end connected to the driving unit 203. Alternatively, the loop circuit 301 may be connected simultaneously between the electric circuit 103 and amplifier unit 202 and to both of the electric circuit 103 and driving unit 203. The loop circuit 301 may be connected partially to the electric circuit 103 (or internally to the electric circuit 103). In this way, the loop circuit 301 may be connected to a closed loop formed by the sensor array 201, amplifier unit 202, electric circuit 103, and driving unit 203.

The loop circuit selecting unit 302 may select the direction of current flowing through the loop circuits 301a and 301b to connect the loop circuits 301a and 301b and thus adjust the voltage/current. For example, the loop circuit 301a may have an end A connected to a connection end E of the electric circuit 103 and an end B connected to a connection end F of the amplifier unit 202 or the end A to the connection end F and the end to the connection end E. Similarly, the loop circuit 301b may have an end C connected to the connection end E of the electric circuit 103 and an end D connected to a connection end F of the amplifier unit 202 or the end C to the connection end F and the end D to the connection end E.

The form of the loop circuit 301 is not limited if at least one of lines (virtual lines) passing within a surface of the loop circuit 301 and perpendicular to the surface crosses one of the sensor array 201, amplifier unit 202, and driving unit 203. According to this embodiment, the loop circuit 301 is arranged such that a surface of the loop circuit 301 is directed in the same direction as that of at least one of the sensor array 201, amplifier unit 202, and driving unit 203.

It should be noted that FIG. 3 illustrates a method which selects two loop circuits 301a and 301b, for example, but there is not upper limit to the number of loop circuits 301. The plurality of loop circuits 301 may be connected in series or in parallel. All or a part of the plurality of loop circuits 301 may have a same characteristic.

The method has been described up to this point with reference to FIG. 3 in which the loop circuit selecting unit 302 connects a loop circuit to at least one of the amplifier unit 202, driving unit 203, and electric circuit 103, for example. However, the loop circuit selecting unit 302 may select a state that no loop circuit is used. More specifically, with reference to FIG. 3, for example, the connection end E and connection end F may be directly connected without through any loop circuit, or a state that both of the connection ends E and F are not connected anywhere may be selected.

FIG. 4 illustrates a second example of the magnetic-field influence inhibiting unit 104.

In the second example of the magnetic-field influence inhibiting unit 104 illustrated in FIG. 4, an inductance as a characteristic of a loop circuit is changed to change current/voltage generated by the law of electromagnetic induction. The second example of the magnetic-field influence inhibiting unit 104 has a characteristic-variable loop circuit 401 and a core-material position changing mechanism 402.

The core-material position changing mechanism 402 is a mechanism having a screw to be turned for moving a member functioning as an internal core in one axial direction. The magnetic field flowing through a loop of the characteristic-variable loop circuit 401 changes in accordance with the positional relationship between the core and the characteristic-variable loop circuit 401, and the current/voltage generated by the law of electromagnetic induction may be adjusted in accordance with the change.

FIG. 4 illustrates an example that the characteristic-variable loop circuit 401 is a coil having a plurality of turns. However, one or more loops (or turns of coils) may be configured by the characteristic-variable loop circuit 401. There is no upper limit to the number of turns of the coil.

It should be noted that the functions of the magnetic-field influence inhibiting unit 104 are given in FIGS. 3 and 4 for illustration purposes only. More specifically, the configuration of the magnetic-field influence inhibiting unit 104 is not limited to the one illustrated in FIGS. 3 and 4, and the configuration is only required to change current/voltage generated within the X-ray image pickup apparatus 101.

It is required that the magnetic-field influence inhibiting unit 104 is operated or instructed to acquire a state suitable for an operating environment of the magnetic-field influence inhibiting unit 104 in the X-ray image pickup apparatus 101. The operation or instruction may be given either manually or automatically. The operation or instruction to be given to the magnetic-field influence inhibiting unit 104 for acquiring a suitable state to the operating environment may be determined manually or automatically.

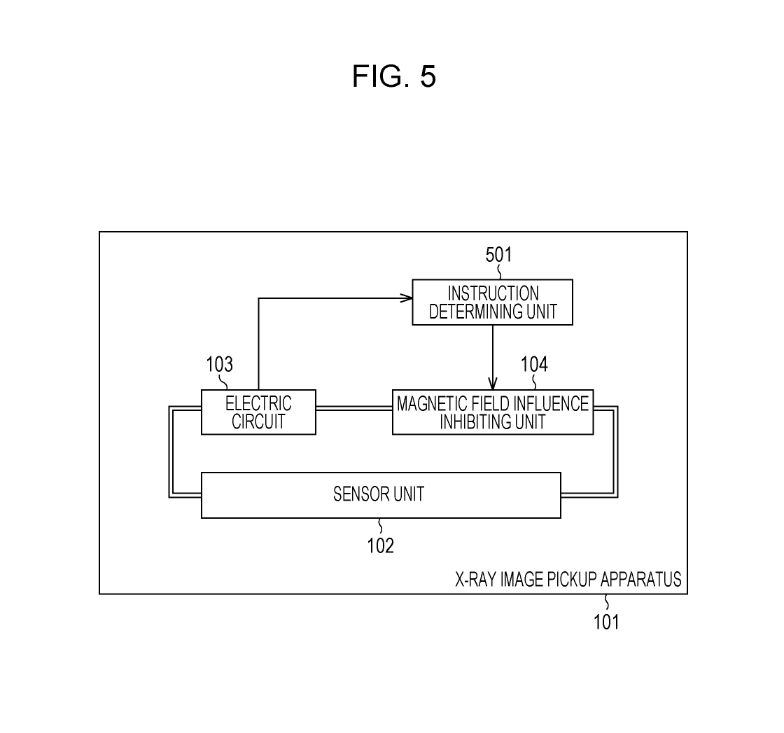

FIG. 5 illustrates an example of a schematic configuration of the X-ray image pickup apparatus 101 in a case where a setting for the magnetic-field influence inhibiting unit 104 suitable for an operating environment is determined automatically.

As illustrated in FIG. 5, an instruction determining unit 501 is used for automatically determining a setting for the magnetic-field influence inhibiting unit 104 suitable for an operating environment.

FIG. 5 illustrates an example of an X-ray image pickup system in which the instruction determining unit 501 is internally provided in the X-ray image pickup apparatus 101. However, the instruction determining unit 501 may be provided externally to the X-ray image pickup apparatus 101 in the X-ray image pickup system. In this case, for example, the instruction determining unit 501 may use a communication unit to instruct to capture an image of X-ray non-irradiation image data and instruct to define a setting for the magnetic-field influence inhibiting unit 104 to the X-ray image pickup apparatus 101 and acquire X-ray non-irradiation image data from the X-ray image pickup apparatus 101. The instruction determining unit 501 may further require a storage device and a processing device for performing arithmetic operations. When the instruction determining unit 501 is provided within the X-ray image pickup apparatus 101, a resource present within the X-ray image pickup apparatus 101 may be used to configure the instruction determining unit 501, eliminating the necessity for a specific resource for the instruction determining unit 501. It should be understood that a special resource for the instruction determining unit 501 may be provided.

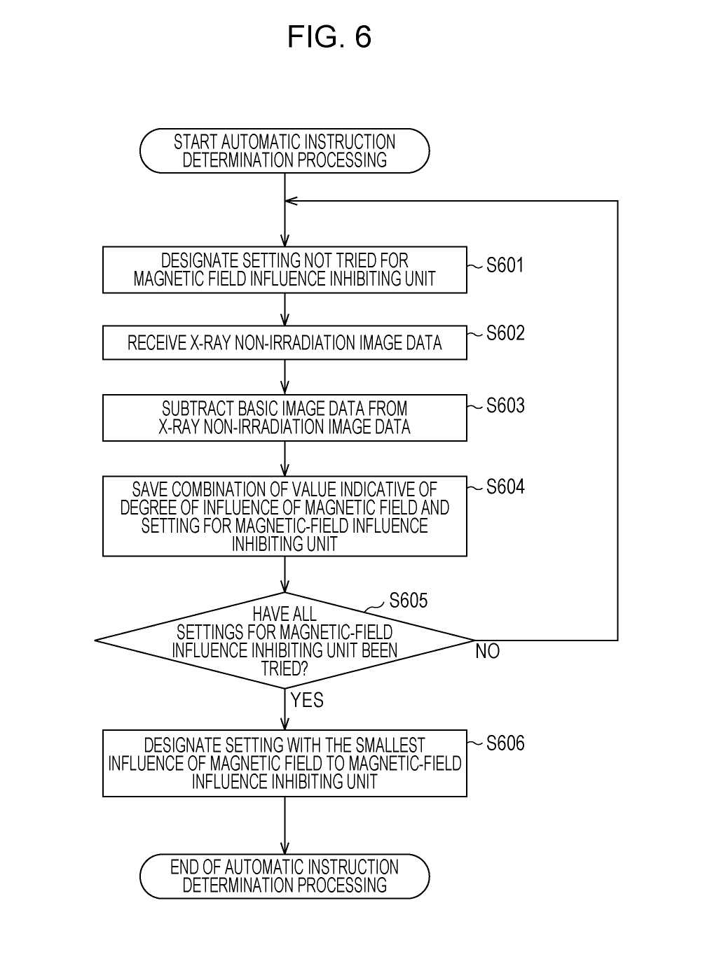

FIG. 6 is a flowchart describing an example of an operation of the instruction determining unit 501.

The instruction determining unit 501 starts designation determining processing on the magnetic-field influence inhibiting unit 104 at an arbitrary timing for define the magnetic-field influence inhibiting unit 104 to fit to an operating environment of the X-ray image pickup apparatus 101. The timing of the start of the designation determining processing to the magnetic-field influence inhibiting unit 104 may be determined in accordance with the operating environment and application of the X-ray image pickup apparatus 101 and is not limited particularly. For example, when capturing an image of a subject is instructed, when a user instructs or a timer triggers during a starting operation for the X-ray image pickup apparatus 101, or when the ray image pickup apparatus 101 is started, designation determining processing may be started on the magnetic-field influence inhibiting unit 104. When designation determining processing is started on magnetic-field influence inhibiting unit 104, a setting for the magnetic-field influence inhibiting unit 104 may be changed based on a round-robin system, and which set value for the magnetic-field influence inhibiting unit 104 is suitable for the current operating environment is determined on basis of data acquired with each of settings.

More specifically, first in step S601, the instruction determining unit 501 outputs to the magnetic-field influence inhibiting unit 104 an instruction to define a setting which has not been tried for the magnetic-field influence inhibiting unit 104 of settings available for the magnetic-field influence inhibiting unit 104. In the first example of the magnetic-field influence inhibiting unit 104 illustrated in FIG. 3, settings are defined of selecting the loop circuit 301 connected to the connection ends E and F and connecting both ends of the selected loop circuit 301 to the connection ends E and F. In the second example of the magnetic-field influence inhibiting unit 104 illustrated in FIG. 4, the operation amount (moving amount of the core) of the core-material position changing mechanism 402 is defined.

Next in step S602, the instruction determining unit 501 outputs to the X-ray image pickup apparatus 101 an instruction to capture an image of the X-ray non-irradiation image data. In response to the instruction, the X-ray image pickup apparatus 101 captures an image without irradiation of an X-ray to generate X-ray non-irradiation image data and transmits it to the instruction determining unit 501. The instruction determining unit 501 receives the X-ray non-irradiation image data.

Next in step S603, the instruction determining unit 501 reads prestored basic image data from a storage medium. Here, the term basic image refers to an image captured by the X-ray image pickup apparatus 101 without X-ray irradiation and without an influence of a magnetic field. The instruction determining unit 501 then performs a subtraction of a pixel value of basic image data from a pixel value of X-ray non-irradiation image data received in step S602 on respective pixels to create image data from which an influence of a magnetic field has been extracted. The processing in step S603 extracts an image having an influence of a magnetic field only.

Next in step S604, the instruction determining unit 501 searches a pixel having the furthest pixel value from a reference pixel value in image data from which an influence of a magnetic field has been extracted, which is acquired in step S603. The instruction determining unit 501 subtracts the reference pixel value from the pixel value of the searched pixel and saves the value as a value indicative of the degree of influence of the magnetic field in combination with the current settings for the magnetic-field influence inhibiting unit 104. Hereinafter, the combination refers to a combination of a value indicative of the degree of an influence of a magnetic field and a setting for the magnetic-field influence inhibiting unit 104 as required.

It should be noted that the reference pixel value here refers to a pixel value of image data from which an influence of a magnetic field has been extracted when X-ray non-irradiation image data received in step S602 is influenced by a magnetic field. When the state of the X-ray image pickup apparatus 101 capturing the X-ray non-irradiation image data received in step S602 is the same as the state of the one capturing basic image data, the X-ray non-irradiation image data and basic image data should be equal as far as they are not influenced by a magnetic field. In this case, the reference pixel value is equal to 0.

On the other hand, when the state of the X-ray image pickup apparatus 101 capturing the X-ray non-irradiation image data received in step S602 is different from the state of the one capturing basic image data, there is a possibility that the X-ray non-irradiation image data and the basic image data may not be equal. For example, when an offset value is added equally to a captured image because of a change of a setting for the X-ray image pickup apparatus 101, the image data from which an influence of a magnetic field has been extracted is not equal to 0 and the offset value appears even though the acquired X-ray non-irradiation image data is not influenced by a magnetic field. Thus, when it is predictable that an offset value, for example, may be added to image data from which an influence of a magnetic field has been extracted, the reference pixel value may be defined in consideration of the offset value.

Next in step S605, the instruction determining unit 501 determines whether all settings for the magnetic-field influence inhibiting unit 104 have been tried or not. If it is determined that all settings for the magnetic-field influence inhibiting unit 104 have not been tried, the processing moves to step S601.

On the other hand, if all settings for the magnetic-field influence inhibiting unit 104 have tried, the processing moves to step S606. In step S606, the instruction determining unit 501 extracts a setting for the magnetic-field influence inhibiting unit 104 having the lowest value indicative of the degree of an influence of a magnetic field on basis of a combination of a value indicative of the degree of an influence of a magnetic field and a setting for the magnetic-field influence inhibiting unit 104, which is saved in step S604. The instruction determining unit 501 instructs the magnetic-field influence inhibiting unit 104 to define the extracted setting. Thus, the settings for the magnetic-field influence inhibiting unit 104 have the smallest influence of a magnetic field.

Here, a value acquired by subtracting a reference pixel value from the furthest pixel value from the reference pixel value in the image data from which an influence of a magnetic field has been extracted, which is acquired in steps S604 and S603 indicates the degree of the influence of the magnetic field. However, this may not always be required.

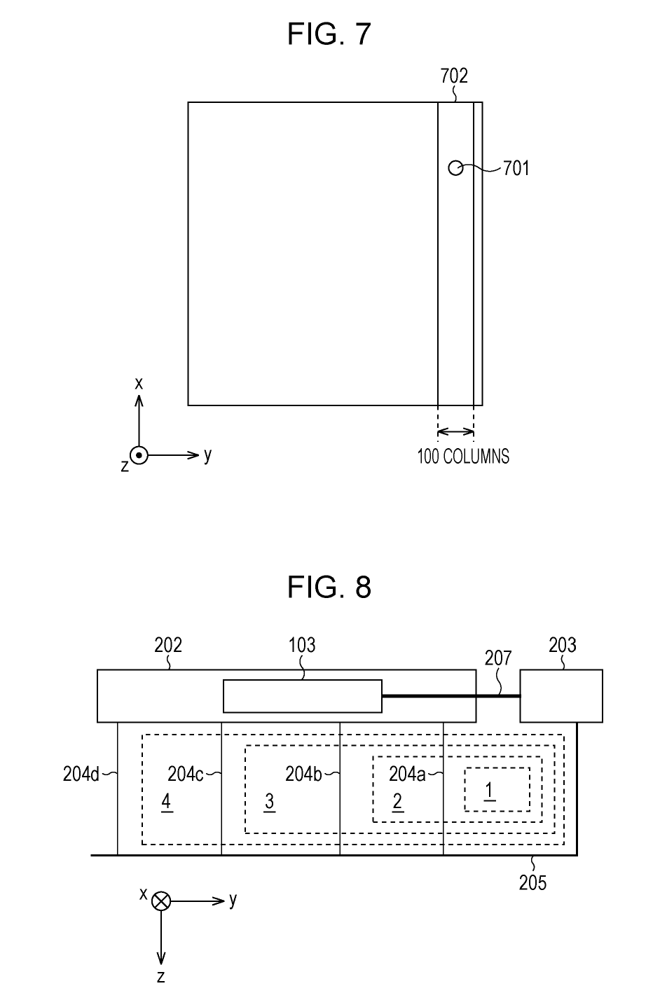

FIG. 7 illustrates a variation example of a method of deriving a value indicative of the degree of an influence of a magnetic field from image data from which the influence of the magnetic field has been extracted. The x, y, and z axes correspond to the x, y, and z axes illustrated in FIG. 2. Referring to FIG. 7, the instruction determining unit 501 first extracts a pixel 701 having the furthest pixel value from a reference pixel value in image data from which an influence of a magnetic field has been extracted. Next, the instruction determining unit 501 extracts columns for 49 left pixels and columns for 50 right pixels from the extracted pixel 701. It should be noted that the range of columns to be extracted is not limited thereto as far as the range includes the pixel 701. Next, the instruction determining unit 501 calculates an average value of pixel values row by row of the image of the strip extraction range 702 (for (100 columns) (where the X-axis direction is a row direction, and the Y-axis direction is a column direction). Next, the instruction determining unit 501 derives a line graph that is a graph waveform having a horizontal axis indicating row numbers and a vertical axis indicating calculated average values. Next, the instruction determining unit 501 derives a value acquired by subtracting the lowest value from the highest value on the line graph as a value indicative of the degree of an influence of a magnetic field. The value indicative of the degree of an influence of a magnetic field may be derived in this way.

Moreover, having described that settings for the magnetic-field influence inhibiting unit 104 are changed based on a round-robin system, it is not limited thereto. For example, effective settings for the magnetic-field influence inhibiting unit 104 may be narrowed down on basis of a characteristic of image data from which an influence of a magnetic field has been extracted.

FIG. 8 illustrates an example of an arrangement of the sensor unit 102 and electric circuit 103 in the height direction. More specifically, FIG. 8 is a view of a surface on the sensor array 201 side of the amplifier unit 202 with the longitudinal direction of the amplifier unit 202 as the horizontal direction of FIG. 8. The x, y and z axes illustrated in FIG. 8 correspond to the x, y and z axes illustrated in FIG. 2.

In the example illustrated in FIG. 8, four apertures 1 to 4 are recognized. In this case, assuming that a magnetic field enters equally to the apertures 1 to 4, the induced current or voltage applied to the amplifier unit 202 that is configured to receive pixel data from the sensor array 201 is different between the read signal lines 204a to 204d. Because the read signal lines 204a to 204d are wiring for passing an output of the sensor array 201, when an influence of a magnetic field occurs during an imaging operation, the captured image may have a distribution based on the degree of influences of the magnetic field.

Using this phenomenon, the incident direction of a magnetic field and a characteristic of an influence of the magnetic field appearing on an image are acquired in advance, and a relationship between the incident direction of the magnetic field and the characteristic of the image influenced by the magnetic field if any is prestored. Hereinafter, the relationship refers to a relationship between the incident direction of a magnetic field and a characteristic of an image as required. Settings for the magnetic-field influence inhibiting unit 104 may be narrowed down by performing the following processing in the automatic instruction determining processing described in FIG. 6, for example.

The instruction determining unit 501 determines whether any image characteristic among characteristics of an image in a relationship between incident directions of a magnetic field and characteristics of the images is matched with or close to a characteristic of image data from which an influence of a magnetic field has been extracted or not. If it is determined that there is an image characteristic matched with or close to a characteristic of the image data from which an influence of a magnetic field has been extracted, the instruction determining unit 501 identifies the incident direction of the magnetic field corresponding to the image characteristic on basis of the relationship between the incident direction of the magnetic field and the image characteristics. The instruction determining unit 501 only defines in step S601 a setting for the loop circuit having a surface direction matched with the identified incident direction of the magnetic field among settings for the magnetic-field influence inhibiting unit 104. In step S606, whether all settings for the direction perpendicular to a surface of the loop circuit matched with the identified incident direction of the magnetic field among settings for the magnetic-field influence inhibiting unit 104 have been tried or not is determined. Thus, the processing time is shorter than that of the processing of changing settings for the magnetic-field influence inhibiting unit 104 based on a round-robin system.

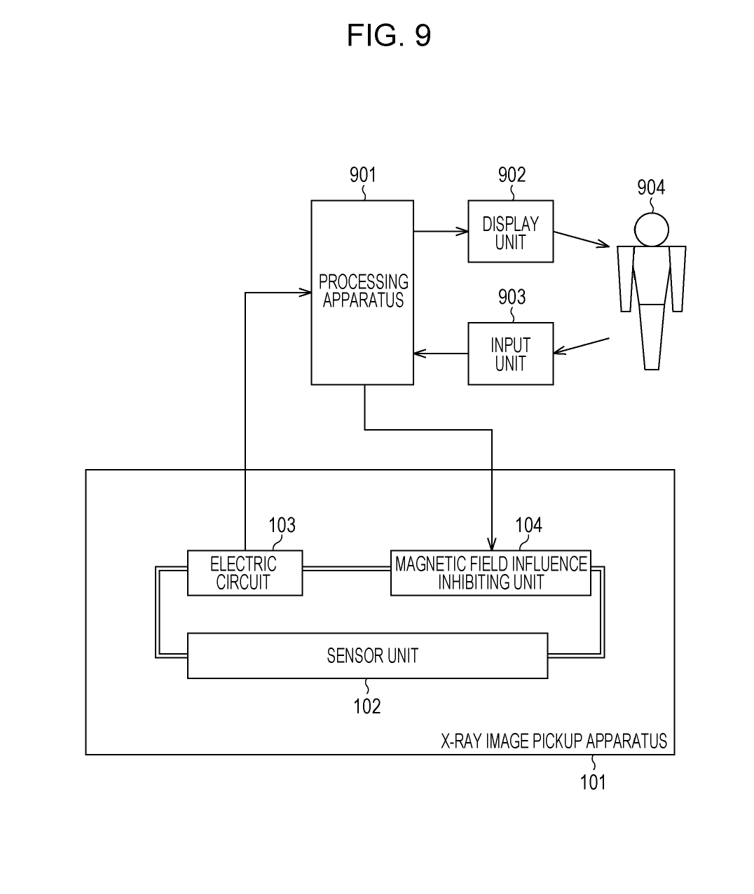

FIG. 9 illustrates an example of a schematic configuration of the X-ray image pickup apparatus 101 in a case where a setting for the magnetic-field influence inhibiting unit 104 suitable for an operating environment is determined (manually) on basis of an operation by a user. This configuration may require a function of notifying information to a user and a mechanism allowing a user to instruct the magnetic-field influence inhibiting unit 104.

In the example illustrated in FIG. 9, a processing device 901 is provided externally to the X-ray image pickup apparatus 101. The processing device 901 may instruct to capture an image of X-ray non-irradiation image data, instruct to define a setting for the magnetic-field influence inhibiting unit 104, acquire X-ray non-irradiation image data from the X-ray image pickup apparatus 101, and calculate the degree of an influence of a magnetic field. The processing device 901 may display information on the display unit 902 and analyze an input operation by a user 904 to an input unit 903. FIG. 9 illustrates an example in which the processing device 901 is provided externally to the X-ray image pickup apparatus 101. However, the processing device 901 may be provided within the X-ray image pickup apparatus 101.

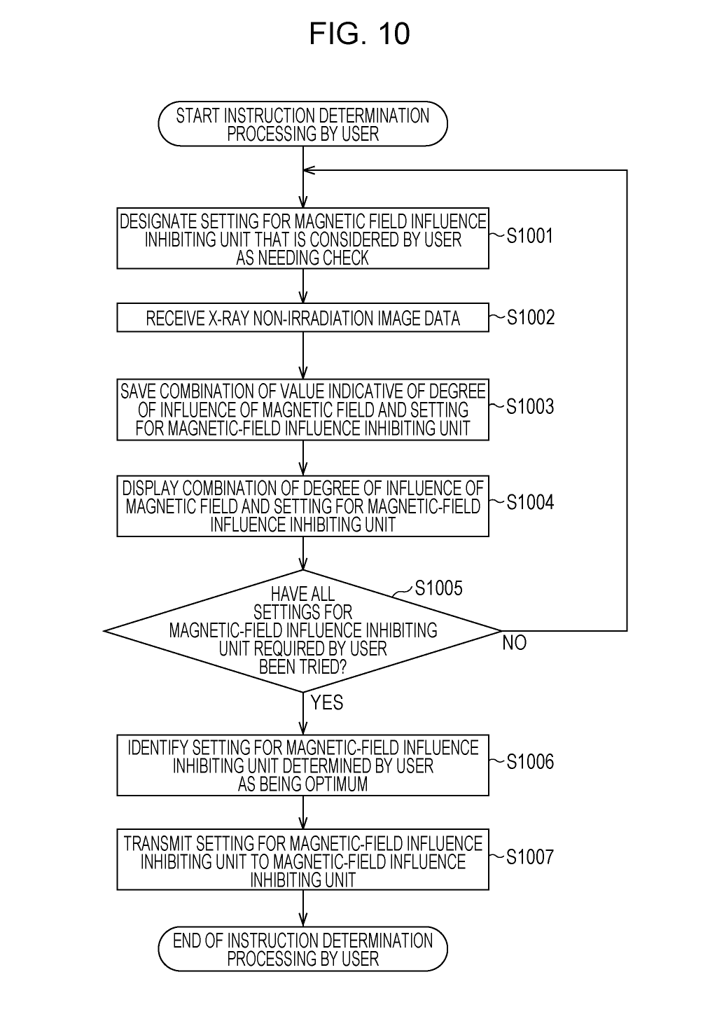

FIG. 10 is a flowchart describing an example of an operation of the processing device 901.

The user 904 may start designation determining processing on the magnetic-field influence inhibiting unit 104 to acquire settings for the magnetic-field influence inhibiting unit 104 suitable for an operating environment of the X-ray image pickup apparatus 101 at a timing when the user 904 recognizes it is necessary. The timing of the start of the designation determining processing on the magnetic-field influence inhibiting unit 104 may be determined in accordance with the operating environment and type of usage of the X-ray image pickup apparatus 101 and is not particularly limited, like the automatic instruction determining processing described with reference to FIG. 6. In other words, the processing in FIG. 10 may be started at a timing when the user 904 recognizes that it is necessary. When the designation determining processing on the magnetic-field influence inhibiting unit 104 starts, image data from which an influence of a magnetic field has been extracted is acquired with a setting for the magnetic-field influence inhibiting unit 104 which is recognized by the user 904 as being necessary to check among settings for the magnetic-field influence inhibiting unit 104. On basis of the result, the setting considered by the user 904 as being optimum is given to the magnetic-field influence inhibiting unit 104.

In step S1001, the user 904 may use the input unit 903 to instruct to define a setting for the magnetic-field influence inhibiting unit 104 recognized by the user 904 as being necessary to check. The processing device 901 obtains information on the setting.

Next in step S1002, the processing device 901 outputs to the X-ray image pickup apparatus 101 an instruction to capture an image of X-ray non-irradiation image data. In response to the instruction, the X-ray image pickup apparatus 101 captures an image without irradiation of an X-ray to create X-ray non-irradiation image data and transmits it to the processing device 901. The processing device 901 receives the X-ray non-irradiation image data.

Next in step S1003, the processing device 901 derives and saves a combination of a value indicative of the degree of an influence of a magnetic field and a setting for the magnetic-field influence inhibiting unit 104. Because the processing in step S1003 is the same as the processing in steps S603 and S604 in FIG. 6, the detail description will be omitted.

Next in step S1004, the processing device 901 outputs(displays) to the display unit 902 the combination of a value indicative of the degree of an influence of the magnetic field and a setting for the magnetic-field influence inhibiting unit 104, which is acquired in step S1003. The user 904 checks the combination of the value indicative of the degree of an influence of a magnetic field and a setting for the magnetic-field influence inhibiting unit 104, which is output (displayed) in step S1004.

Next in step S1005, the processing device 901 determines whether all of settings for the magnetic-field influence inhibiting unit 104 recognized by the user 904 as being necessary to check have been tried or not on basis of an operation on the input unit 903 by the user 904. If it is determined that all of settings for the magnetic-field influence inhibiting unit 104 recognized by the user 904 as being necessary to check have not been tried, the processing returns to step S1001.

On the other hand, if it is determined that all of settings for the magnetic-field influence inhibiting unit 104 recognized by the user 904 as being necessary to check have been tried, the processing moves to step S1006. In step S1006, the processing device 901 identifies a setting for the magnetic-field influence inhibiting unit 104 determined as being optimum by the user 904 on basis of an operation on the input unit 903 by the user 904.

Next in step S1007, the processing device 901 instructs the magnetic-field influence inhibiting unit 104 to define the setting identified in step S1006. Thus, the settings for the magnetic-field influence inhibiting unit 104 have the smallest influence of a magnetic field.

In this way, according to this embodiment, an image is captured without irradiation of an X-ray to generate X-ray non-irradiation image data. Then, image data from which an influence of a magnetic field has been extracted and which only has an influence of a magnetic field is created on basis of basic image data captured by the X-ray image pickup apparatus 101 without irradiation of an X-ray, a subject and an influence of a magnetic field and the X-ray non-irradiation image data. Then, a value indicative of the degree of an influence of the magnetic field that is a value indicating an influence of a magnetic field is derived from the image data from which an influence of a magnetic field has been extracted. The value indicative of the degree of an influence of a magnetic field is derived sequentially with a plurality of settings for the magnetic-field influence inhibiting unit 104 (such as the number and connecting method of the loop circuits 301 and a magnetic characteristic such as an inductance and an electric characteristic such as a direct current resistance in the characteristic-variable loop circuit 401). The setting for the magnetic-field influence inhibiting unit 104 which produces the lowest value indicative of the degree of an influence of a magnetic field is adopted.

Thus, when current/voltage which has an influence on creation of an image occurs within the X-ray image pickup apparatus 101 due to existence of a magnetic field within an operating environment of the X-ray image pickup apparatus 101, current/voltage may be generated in the direction that cancels the current/voltage which has an influence on creation of an image. Furthermore, the size and direction of the current/voltage which has an influence on creation of an image may be adjusted. Therefore, an influence of a magnetic field within an operating environment given on the X-ray image pickup apparatus 101 may be reduced with a simple configuration based on a given condition, without requiring a unit that requires resources and time for image processing, for example. According to this embodiment, an influence of an external magnetic field on creation of an image in the X-ray image pickup apparatus 101 may be reduced without addition of complicated signal processing or a major configuration.

In this case, in order to inhibit voltage/current occurring in the X-ray image pickup apparatus 101 due to a magnetic field within an operating environment, a loop circuit which generates voltage/current in the reverse direction may be provided. However, because the direction and distribution of a magnetic field within an operating environment depend on the environment, it is not easy to provide a loop circuit that is suitable to all environments within the X-ray image pickup apparatus 101. Providing a loop circuit suitable for operating environments if any may require check and analysis of a relationship between a magnetic field present within the operating environment and the X-ray image pickup apparatus 101 before the loop circuit is created. Conversely, according to this embodiment, the number and connecting method of loop circuits may be selected, which eliminates the necessity for providing loop circuits suitable for the operating environments.

### Second Embodiment

Next, a second embodiment of the present invention will be described. According to this embodiment, processing of detecting an influence of a magnetic field occurring instantly is added to the instruction determining processing (FIG. 6 and FIG. 10) on the magnetic-field influence inhibiting unit 104 according to the first embodiment. In other words, according to this embodiment, processing of detecting an influence of a magnetic field occurring instantly is added to the first embodiment. Like numbers refer to like parts throughout, and detail description will be omitted.

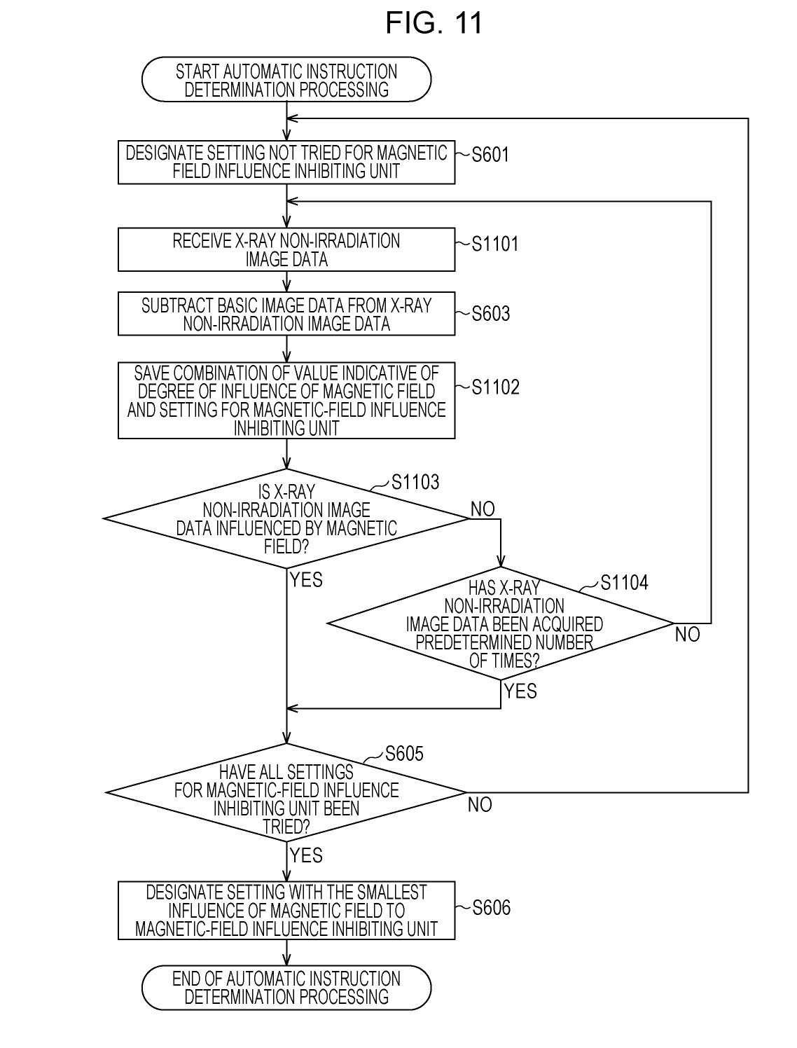

FIG. 11 is a flowchart describing an example of an operation of the instruction determining unit 501.

The flowchart on FIG. 11 has steps S1101 to S1104 instead of the steps S602 and S604 on the flowchart in FIG. 6.

In step S1101, the instruction determining unit 501 outputs to the X-ray image pickup apparatus 101 an instruction to capture an image of X-ray non-irradiation image data. In response to the instruction, the X-ray image pickup apparatus 101 captures an image without irradiation of an X-ray to create X-ray non-irradiation image data and transmits it to the instruction determining unit 501. The instruction determining unit 501 receives the X-ray non-irradiation image data. When the processing in step S1101 is performed, whether the acquired image is influenced by a magnetic field occurring instantly or not is not known.

In step S1102, the instruction determining unit 501 searches a pixel having the furthest pixel value from a reference pixel value in image data from which an influence of a magnetic field has been extracted, which is acquired in step S603. The instruction determining unit 501 subtracts the reference pixel value from the pixel value of the searched pixel and saves the value as a value indicative of the degree of influence of the magnetic field in combination with the current settings for the magnetic-field influence inhibiting unit 104.

Next in step S1103, the instruction determining unit 501 determines whether the X-ray non-irradiation image data acquired in step S1101 is influenced by a magnetic field or not on basis of the value indicative of the degree of an influence of a magnetic field, which is derived in step S1102.

If it is determined that the X-ray non-irradiation image data acquired in step S1101 is influenced by the magnetic field, the processing moves to step S605.

On the other hand, if the X-ray non-irradiation image data acquired in step S1101 is not influenced by a magnetic field, the processing moves to step S1104. In step S1104, the instruction determining unit 501 determines whether the X-ray non-irradiation image data has been obtained a preset number of times or not. If it is determined that the X-ray non-irradiation image data has been obtained the preset number of times, the processing moves to step S605. On the other hand, if it is determined that the X-ray non-irradiation image data has not been obtained the preset number of times, the processing returns to step S1101.

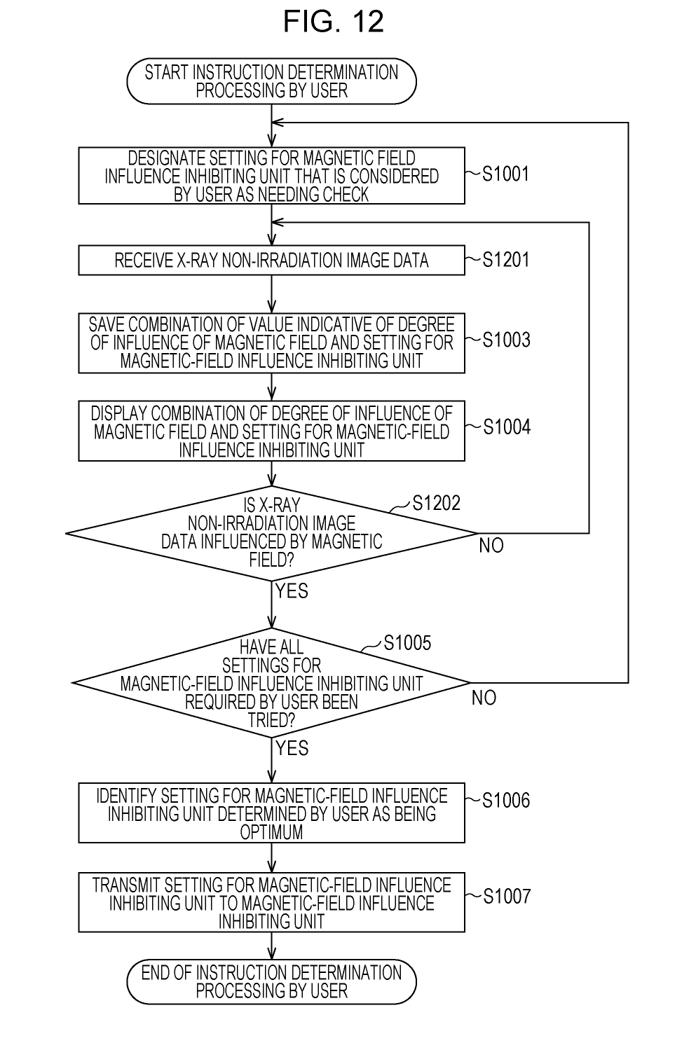

FIG. 12 is a flowchart describing an example of an operation of the processing device 901. The flowchart on FIG. 12 has steps S1201 and S1202 instead of step S1002 on the flowchart in FIG. 10.

In step S1201, the processing device 901 outputs to the X-ray image pickup apparatus 101 an instruction to capture an image of the X-ray non-irradiation image data. In response to the instruction, the X-ray image pickup apparatus 101 captures an image without irradiation of an X-ray to generate X-ray non-irradiation image data and transmits it to the processing device 901. The processing device 901 receives the X-ray non-irradiation image data.

In step S1202, the processing device 901 determines whether X-ray non-irradiation image data acquired in step S1201 is influenced by a magnetic field or not on basis of the value indicative of the degree of an influence of a magnetic field, which is derived in step S1003.

If it is determined that the X-ray non-irradiation image data acquired in step S1201 is influenced by a magnetic field, the processing moves to step S1005.

On the other hand, if the X-ray non-irradiation image data acquired in step S1201 is not influenced by a magnetic field, the processing returns to step S1201.

It has been described that if it is determined in step S1202 that the X-ray non-irradiation image data is not influenced by a magnetic field, the processing moves to step S1201, for example. However, before moving to step S1201, whether the X-ray non-irradiation image has been obtained a preset number of times or not may be determined. If it is determined that the X-ray non-irradiation image has been obtained a preset number of times, the processing may move to step S1005. On the other hand, if it is determined that the X-ray non-irradiation image has not been obtained a preset number of times, the processing moves to step S1201. In this case, the method of designating the number of times of acquisition of an X-ray non-irradiation image is not limited particularly. A numerical value prestored in the processing device 901 may be used, or a numerical value input by the user 904 in step S1001 may be used.

Under a condition that a magnetic field is steadily present within an operating environment or under a condition that a magnetic field is steadily present within an operating environment but does not change and the X-ray image pickup apparatus 101 does not move, an image captured by the X-ray image pickup apparatus 101 without irradiation of an X-ray does not have an influence of the magnetic field. This embodiment uses the fact. More specifically, in order to determine whether a captured image has an influence due to an instantaneous magnetic field or not, whether the difference between a pixel value of a captured image and a reference value is equal to or higher than a predetermined value or not is checked and if so it is determined that the captured image is influenced by a magnetic field.

Adding the processing may be provided for a case where an instantaneously occurring magnetic field is present within an operating environment of the X-ray image pickup apparatus 101 and may inhibit current/voltage which may have an influence on creation of an image with a magnetic field which may cancel it.

It should be noted that the variation example according to the first embodiment may also be adopted in this embodiment.

### Third Embodiment

Next, a third embodiment of the present invention will be described. According to this embodiment, the X-ray image pickup apparatus 101 further includes a mechanism of detecting (the presence of) movement of the X-ray image pickup apparatus 101 or a mechanism of detecting (the presence of) movement, the direction of movement and moving amount of the X-ray image pickup apparatus 101. According to this embodiment, such a mechanism is added to the X-ray image pickup apparatus 101 according to the first or second embodiment.

Like numbers refer to like parts throughout, and the detail description will be omitted.

The mechanism to be added to the X-ray image pickup apparatus 101 will be called a movement detecting unit below. If the movement detecting unit detects a movement of the X-ray image pickup apparatus 101, the movement detecting unit notifies a movement notification signal indicating the fact to a part (instruction determining unit 501 or processing device 901) configured to change a setting for the magnetic-field influence inhibiting unit 104. If the part configured to change a setting for the magnetic-field influence inhibiting unit 104 receives the movement notification signal output from the movement detecting unit, the part changes a setting for the magnetic-field influence inhibiting unit 104 to a setting suitable for the operating environment after the movement. In other words, the processing on the flowcharts on FIGS. 6 and 10 to 12 may be executed at a timing when the movement notification signal output from the movement detecting unit is received, instead of the timing described above.

This may eliminate the necessity for giving an instruction to reset the magnetic-field influence inhibiting unit 104 a timing suitable for a user and therefore may reduce user's work load even when the influence of a magnetic field on the X-ray image pickup apparatus 101 is changed by a movement of the X-ray image pickup apparatus 101. It may also eliminate the necessity for processing of resetting every predetermined period of time in a case where the magnetic-field influence inhibiting unit 104 is defined on basis of automatic determination, eliminating unnecessary processing. However, in addition to the timing according to this embodiment, the processing on the flowcharts in FIGS. 6 and 10 to 12 according to the first and second embodiments may be performed.

It should be noted that the variation example according to the first embodiment may also be adopted in this embodiment.

It should be understood that all of the aforementioned embodiments are merely given for illustration of embodiments of the present invention, and the technical scope of the present invention should not be interpreted limitedly. In other words, the present invention may be embodied in various forms without deviating from its technical spirit or main characteristics.

Therefore, an influence of an external magnetic field on creation of an image in the X-ray image pickup apparatus may be reduced without addition of complicated signal processing or a major configuration.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-247683, filed Nov. 9, 2012, which is hereby incorporated by reference herein in its entirety.

What is claimed is:

1. An X-ray image pickup system comprising:
an X-ray image pickup apparatus having
a sensor unit having photoelectric conversion elements arranged in a two-dimensional matrix form, the sensor unit configured to acquire an electric signal corresponding to the intensity of an X-ray generated from an X-ray source by the photoelectric conversion elements and output electric signals as pixel data;
an electric circuit configured to perform processing including driving the sensor unit;
wiring configured to mutually connect the sensor unit and the electric circuit; and
one or more loop circuits each having a loop-shaped conductor and being connected to at least one of an internal component of the electric circuit and the wiring; and
a selection unit configured to perform at least one of selection of a loop circuit to be connected among the loop circuits and selection of a state of the loop circuit to be connected.

2. The X-ray image pickup system according to claim 1, wherein the selection unit has
a setting unit configured to perform selection of at least one of the loop circuits and selection of a state of the loop circuit to be connected and define a plurality of settings as settings for the loop circuit;
a deriving unit configured to derive a value indicating an influence of an external magnetic field in image data acquired by the sensor unit every time the setting unit defines a setting for the loop circuit; and
a determination unit configured to determine a setting for capturing an image of a subject as a setting for the loop circuit to be connected on basis of the value indicating an influence of an external magnetic field derived by the deriving unit.

3. The X-ray image pickup system according to claim 1, wherein the state of the loop circuit is at least one of the size of the loop-shaped conductor, the direction of the loop-shaped conductor, and a characteristic value of the loop circuit.

4. The X-ray image pickup system according to claim 1, wherein
the sensor unit further has
a sensor array having the photoelectric conversion elements arranged in a two-dimensional matrix form;
an amplifier unit configured to receive and amplify pixel data acquired by the photoelectric conversion elements; and
a driving unit configured to select the photoelectric conversion element that reads the pixel data;
the electric circuit is mutually connected with the amplifier unit and the driving unit via the wiring; and
the loop circuit is connected to at least one of the wiring arranged between the amplifier unit and the electric circuit, the wiring arranged between the driving unit and the electric circuit, and an internal component of the electric circuit.

5. The X-ray image pickup system according to claim 1, wherein
one or a plurality of loop circuits are to be connected; and
the plurality of loop circuits are connected in series or in parallel.

6. The X-ray image pickup system according to claim 1, wherein the determination unit automatically determine the loop circuit corresponding to image data having the smallest influence of an external magnetic field as a setting for the loop circuit to be connected on basis of the value indicating the influence of the external magnetic field derived by the deriving unit.

7. The X-ray image pickup system according to claim 1, wherein the X-ray image pickup apparatus has the selection unit.

8. The X-ray image pickup system according to claim 1, wherein, every time when the setting unit defines a setting for the loop circuit, the deriving unit derives a value indicating an influence of an external magnetic field from image data from which the influence of the magnetic field has been extracted that is a difference between image data acquired by the sensor unit under a state that an X-ray is not irradiated and basic image data that is image data acquired in advance by the sensor unit under a state that an X-ray is not irradiated and it could be regarded as that no external magnetic field is present.

9. The X-ray image pickup system according to claim 1, further comprising a display unit configured to display information describing a value indicating an influence of an external magnetic field, which is derived by the deriving unit, wherein
the setting unit sequentially defines a plurality of setting as setting for the loop circuit on basis of an operation by a user; and
the determination unit determines a setting for capturing an image of a subject as a setting for the loop circuit to be connected on basis of an operation by a user based on the information describing the value indicating the influence of the external magnetic field displayed by the display unit.

10. The X-ray image pickup system according to claim 1, further comprising a determining unit configured to determine whether image data acquired by the sensor unit is influenced by an external magnetic field or not on basis of the value indicating an influence of an external magnetic field, which is derived by the deriving unit, wherein
the setting unit defines a plurality of settings as settings for the loop circuit until the determining unit determines that image data acquired by the sensor unit is influenced by an external magnetic field or until settings for the loop circuit are defined a preset number of times.

11. The X-ray image pickup system according to claim 1, further comprising a detecting unit configured to detect a movement of the X-ray image pickup apparatus, wherein
the selection unit performs at least one of selection of the loop circuit to be connected among the plurality of loop circuits and selection of a state of the loop circuit to be connected if the detecting unit detects a movement of the X-ray image pickup apparatus.

12. An X-ray image pickup apparatus comprising:
a sensor unit having photoelectric conversion elements arranged in a two-dimensional matrix form, the sensor unit configured to acquire an electric signal corresponding to the intensity of an X-ray generated from an X-ray source by the photoelectric conversion elements and output electric signals as pixel data;
an electric circuit configured to perform processing including driving the sensor unit;
wiring configured to mutually connect the sensor unit and the electric circuit;
one or more loop circuits each having a loop-shaped conductor and being connected to at least one of an internal component of the electric circuit and the wiring; and
a selection unit configured to perform at least one of selection of a loop circuit to be connected among the loop circuits and selection of a state of the loop circuit to be connected.

13. A control method for an X-ray image pickup apparatus having
a sensor unit having photoelectric conversion elements arranged in a two-dimensional matrix form, the sensor unit configured to convert the intensity of an X-ray generated from an X-ray source by the photoelectric conversion elements to an electric signal and output electric signals as pixel data;
an electric circuit configured to perform processing including driving the sensor unit;
wiring configured to mutually connect the sensor unit and the electric circuit; and
one or more loop circuits each having a loop-shaped conductor and being connected to at least one of an internal component of the electric circuit and the wiring,
the method comprising performing at least one of selection of a loop circuit to be connected among the loop circuits and selection of a state of the loop circuit to be connected.
